(19) United States
(12) Patent Application Publication
(10) Pub. No.: US 2013/0240689 A1
(43) Pub. Date: Sep. 19, 2013

(54) TRAY FOR PIZZAS AND SANDWICHES THAT PROVIDES ADVERTISING

(71) Applicant: Mark McCormack, West Chester, OH (US)

(72) Inventor: Mark McCormack, West Chester, OH (US)

(21) Appl. No.: 13/776,565

(22) Filed: Feb. 25, 2013

Related U.S. Application Data
(60) Provisional application No. 61/612,045, filed on Mar. 16, 2012.

(51) Int. Cl. F16M 11/00

(52) U.S. Cl. CPC F16M 11/00
USPC 248/163.1

(57) ABSTRACT

A molded plastic table has a removable advertising piece made of plastic, cardboard, label material, magnetic material, or the like, that can be used for couponing, collecting, or as a refrigerator magnet for future advertising. The table can act as a device to support a carton top while providing for an advertising vehicle.

### CROSS-REFERENCE TO RELATED APPLICATION

This application claims the benefit of priority of U.S. provisional application No. 61/612,045, filed Mar. 16, 2012, the contents of which are herein incorporated by reference.

### BACKGROUND OF THE INVENTION

The present invention relates to advertising methods and apparatus and, more particularly, to a plastic molded tray for pizzas and sandwiches for advertising that holds a removable plastic, metal, cardboard, wood, magnetic material, or that can provide advertising for that company or other companies via the delivery of the product and service.

Pizza, fast food and other consumable products are a very competitive area that requires a considerable amount of reinforcement advertisement. Currently, the best way to advertise is to attach a flyer to the outside of the box. Current pizza or sandwich box tables have no means to deliver any type of additional advertising piece.

Current tables to hold a pizza or sandwiches have no advertising value. Typically, these items are simply placed with the delivery to, for example, keep the box from collapsing, but do not have any printing or other material associated with them.

As can be seen, there is a need for an improved method and apparatus for providing advertising with a tray for pizza or sandwiches.

### SUMMARY OF THE INVENTION

In one aspect of the present invention, an advertisement delivery and crush prevention device comprises a platform; a plurality of legs supporting the platform; a non-toxic adhesive disposed on the platform; and an advertisement top piece removably attached to the platform via the non-toxic adhesive.

In another aspect of the present invention, a method for preventing a container top piece from contacting a food item inside a container while delivering advertising to a user comprises disposing the food item on a bottom piece of the container; placing legs of an advertisement delivery and crush prevention device into the food item, the advertisement delivery and crush prevention device having a platform supported by the legs, a non-toxic adhesive disposed on the platform and an advertisement top piece removably attached to the platform via the non-toxic adhesive; and closing the container top piece over the food item to close the container, wherein the advertisement delivery and crush prevention device holds the container piece from contacting the food item when pressure is applied to an exterior surface of the container top piece.

These and other features, aspects and advantages of the present invention will become better understood with reference to the following drawings, description and claims.

### BRIEF DESCRIPTION OF THE DRAWINGS

FIG. 1 is a top perspective view of an advertisement delivery and crush prevention device according to an exemplary embodiment of the present invention;

FIG. 2 is a bottom perspective view of the advertisement delivery and crush prevention device of FIG. 1;

FIG. 3 is an exploded perspective view of the advertisement delivery and crush prevention device of FIG. 1;

FIG. 4 is a perspective view illustrating an exemplary use of the advertisement delivery and crush prevention device of FIG. 1

FIG. 5 is a cross-sectional view taken along line 5-5 of FIG. 4; and

FIG. 6 is a perspective view of an advertisement delivery and crush prevention device having a square-shaped advertisement disposed thereupon.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a molded plastic table with a removable advertising piece made of plastic, cardboard, label material, magnetic material, or the like, that can be used for couponing, collecting, or as a refrigerator magnet for future advertising. The table can act as a device to support a carton top while providing for an advertising vehicle.

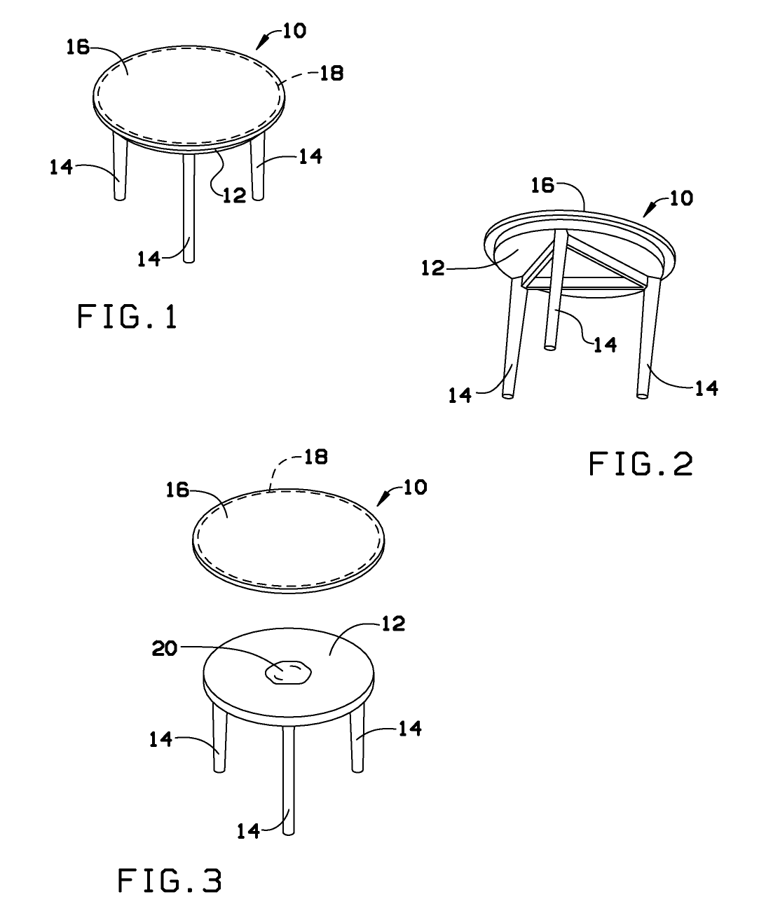

Referring to FIGS. 1 through 4, an advertisement delivery and crush prevention device 10 can include a platform 12 supported by a plurality of legs 14. Typically, when the platform 12 is round in shape, as shown in the Figures, three legs 14 are disposed to extend from a bottom side of the platform 12.

An advertisement top piece 16 can be attached to an upper side of the platform 12. An advertisement region 18 is provided on one or both sides of the advertisement top piece 16 to provide advertisements, collectable pieces, custom designs, and the like. The advertisement top piece 16 can attach to the platform 12 with a non-toxic fugitive adhesive 20.

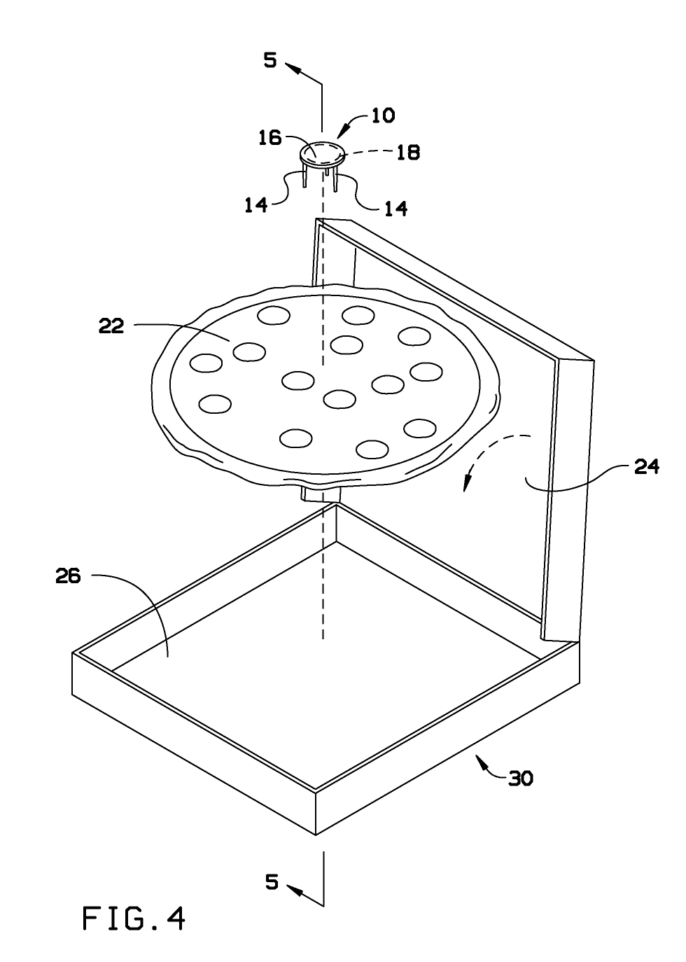

A seller, such as a pizza shop for example, can place a food item, such as a pizza 22 into a food item container bottom piece 26 of a food container 30, as shown in FIGS. 4 and 5. The advertisement delivery and crush prevention device 10 can be positioned on the pizza 22. When a food item container top piece 24 is closed over the food item container bottom piece 26, the advertisement delivery and crush prevention device 10 can prevent the food item container top piece 24 from coming into contact with the pizza 22. Unlike conventional trays, the advertisement deliver and crush prevention device 10 of the present invention includes the advertisement top piece 16, which can be removed from the platform 12 and saved for future use.

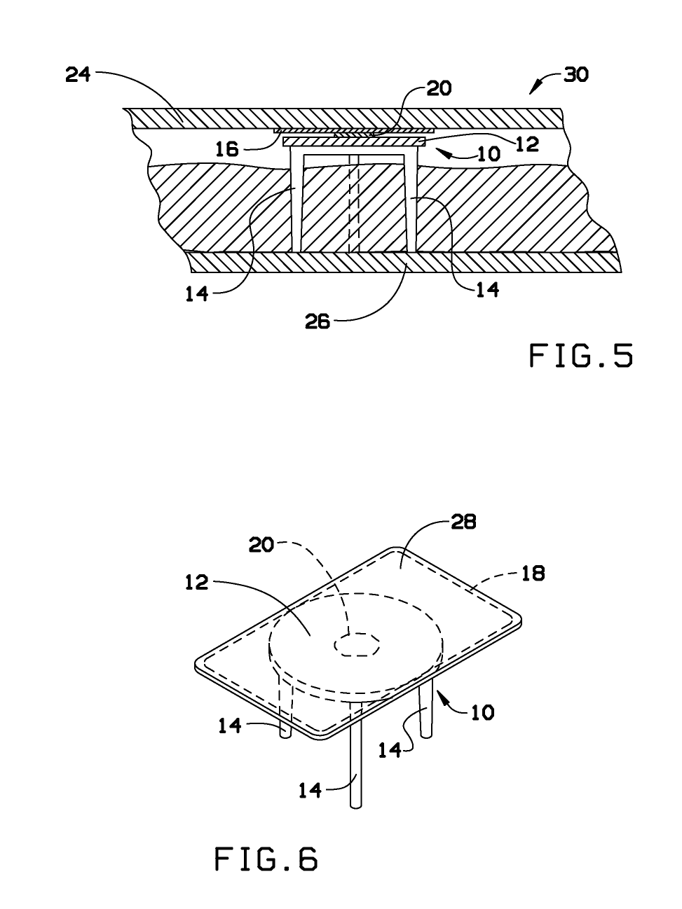

As shown in FIG. 6, a rectangular advertisement top piece 28 can be used in place of the round advertisement top piece 16 described above with reference to FIGS. 1 through 5. Moreover, any desired shape can be used for the advertisement top piece, including geometric shapes such as triangles, pentagons, hexagons, or the like, and non-geometric shapes.

For the advertisement delivery and crush prevention device 10 of FIGS. 1 through 6, the platform 12 can be made in various sizes, ranging from about 1 to about 4 inches in diameter, typically from about 2 to about 3 inches in diameter.

While the Figures show a round platform 12 supported by three legs 14, other shapes and sizes are contemplated for the platform within the scope of the present invention. For example, the platform can be made in a square or rectangular shape, having four legs 14.

The advertisement delivery and crush prevention device 10 may be made from various materials. Typically, they may be made from a plastic, disposable or recyclable material. The advertisement delivery and crush prevention device 10 may be made in various colors and may include various printing thereupon in addition to printing disposed on the advertising top piece.

The advertising top piece can be made in various sizes to fit the same size of, to be smaller than, or to be larger than the platform 12. The advertising top piece may be made of card stock from 10 to 50 mils, plastic, metal, pressure sensitive label stock, a magnetic material or the like. The advertising piece may be printed on the front and/or back thereof to fit the needs of the advertiser. The advertising piece could include additional features, such as glow-in-the-dark, lights, three-dimensional printing, or the like.

The advertisement delivery and crush prevention device 10 may be made from processes known in the art, such as plastic injection molding, for example. The advertising top piece can also be made by various processes and may be printed through various processes such as screen printing, digital printing, flexographic pressing, or the like.

While the above description discussed the advertisement delivery and cruise prevention device 10 as usable in a pizza box, the advertisement delivery and crush prevention device 10 may be used in a variety of applications. For example, they may be configured to be used in/as beverage containers, fast food containers, coffee/soft drink lids, and other direct to the consumer products where couponing or advertising would be important.

It should be understood, of course, that the foregoing relates to exemplary embodiments of the invention and that modifications may be made without departing from the spirit and scope of the invention as set forth in the following claims.

What is claimed is:

1. An advertisement delivery and crush prevention device comprising:
a platform;
a plurality of legs supporting the platform;
a non-toxic adhesive disposed on the platform; and
an advertisement top piece removably attached to the platform via the non-toxic adhesive.

2. The advertisement delivery and crush prevention device of claim 1, wherein the platform defines a planar surface for supporting a top piece of a food container away from food disposed in the food container.

3. The advertisement delivery and crush prevention device of claim 1, wherein the platform is round in shape, having three legs extending therefrom.

4. The advertisement delivery and crush prevention device of claim 1, wherein the advertisement top piece includes at least one of an advertisement, a collectable and a magnet.

5. The advertisement delivery and crush prevention device of claim 1, wherein the non-toxic adhesive is a fugitive adhesive.

6. The advertisement delivery and crush prevention device of claim 1, wherein the advertisement top piece covers the platform.

7. A method for preventing a container top piece from contacting a food item inside a container while delivering advertising to a user, comprising:
disposing the food item on a bottom piece of the container;
placing legs of an advertisement delivery and crush prevention device into the food item, the advertisement delivery and crush prevention device having a platform supported by the legs, a non-toxic adhesive disposed on the platform and an advertisement top piece removably attached to the platform via the non-toxic adhesive; and
closing the container top piece over the food item to close the container, wherein the advertisement delivery and crush prevention device holds the container piece from contacting the food item when pressure is applied to an exterior surface of the container top piece.

8. The method of claim 7, wherein the platform is round in shape, having three legs extending therefrom.

9. The method of claim 7, wherein the advertisement top piece includes at least one of an advertisement, a collectable and a magnet.

10. The method of claim 7, wherein the non-toxic adhesive is a fugitive adhesive.
